(19) United States
(12) Patent Application Publication
(10) Pub. No.: US 2002/0023663 A1
(43) Pub. Date: Feb. 28, 2002

(54) Apparatus and method for preventing the re-adherence of particles in wafer-cleaning process

(75) Inventor: Ching-Yu Chang, Yuan-Shan Hsiang (TW)

Correspondence Address: Benjamin J. Hauptman, LOWE HAUPTMAN GILMAN & BERNER, LLP, Suite 310, 1700 Diagonal Road, Alexandria, VA, 22314, US

(73) Assignee: MACRONIX INTERNATIONAL CO., LTD.

(21) Appl. No.: 09/983,256

(22) Filed: Oct. 23, 2001

Related U.S. Application Data
(62) Division of application No. 09/510,294, filed on Feb. 22, 2000.

(51) Int. Cl. B08B 3/00

(52) U.S. Cl. 134/1.3; 134/102.1; 134/902; 134/103.2; 134/186; 134/36

(57) ABSTRACT

The present invention provides an apparatus for preventing the re-adherence of particles in wafer cleaning process, which comprises a tank containing dissolved high pressure gas water, a cleaning bath for cleaning wafer, and a pipeline connecting the tank and the cleaning bath, such that the high pressure gas water forms a plurality of bubbles on the surface of the wafer and particles after the high pressure gas water in the tank introduction into the cleaning bath, in which the particles near the wafer is push away from the wafer by the bubbles and the particles away from the wafer will not re-adhere to the surface of wafer for the repulsion of the bubbles. The present invention simultaneously provides a method for preventing particle re-adhering in wafer cleaning process, which comprises first providing a tank, a cleaning bath, and a pipeline connecting the tank and the cleaning bath. Then, a dissolved high pressure gas water is provided in the tank. Next, the dissolved high pressure gas water is introduced into the cleaning bath, such that the high pressure gas water forms a plurality of bubbles on the surface of the wafer and particles, in which the particles near the wafer is push away from the wafer by the bubbles and the particles away from the wafer will not re-adhere to the surface of wafer for the repulsion of the bubbles.

### BACKGROUND OF THE INVENTION

1. Field of the Invention

The present invention generally relates to a wafer-cleaning process, and more particularly to an apparatus and method for preventing the re-adherence of particles in a wafer cleaning process.

2. Description of the Prior Art

In ULSI (Ultra Large Scaled Integrated) fabrication, the technique for cleaning wafer and cleanliness are one of the most important elements in fabrication yield, quality, and reliability of a device. In particularly, when the process moves on to the deep submicron, the integrity of a device will reach to millions and billions and the process recipes will be more than hundreds of steps. It is necessary to have very cleanliness on the surface of a wafer in fabricating such a delicate device. Hence, it is on of the most important, conscientious and careful step in ULSI fabrication on how to clean wafer to reach the requirement of cleanliness.

In wafer cleanliness process, it is necessary to use high degree of purity chemical to clean, high degree of purity DI (deionized) water to rinse, and high degree of purity gas (such as He) to dry up in high speed rotation, or high volatile organic solvent (such as IPA) to dry up. The wafer cleaning technique from prior RCA clean recipe by using high degree of purity wet chemical clean has been used more than 30 years and has not been changed yet. The only change is the ratio of chemical recipe and the cleaning sequence, for example, the ratio of SC1 is from NH₄OH:H₂O₂:DI=1:1:5 to NH₄OH:H₂O₂:DI=1:1.5:60.

The purpose of wafer cleaning substantially is by using chemical to remove the contamination, such as particle, organic impurity, metal ions, on the surface of a wafer, and to rinse the impurity by DI water. In ULSI fabrication, because the thickness of gate oxide is less that 100 angstroms, the micro-roughness on the surface of a wafer and the removal of native oxide need to be concerned after cleaning for reaching the requirement of electrical parameters and characteristics in the ultra-thin gate oxide of a semiconductor device, as well as quality and reliability of a device.

The main wet chemical clean recipe is RCA recipe, and can apply to the ULSI fabrication and pre-diffusion in furnace via improvement to develop multi-cleaning recipes, such as pre-diffusion clean, pre-gate oxide clean, and pre-CVD clean. There are three kinds of clean station with different concerns and advantages as well as disadvantages in wet chemical clean process, and the following will set forth the different clean station.

Wet bench cleaning processor is also called immersion chemical station. Referring to FIG. 1, a schematic representation of prior wet bench cleaning processor 10 is shown, which has two chemical chambers 12-1, 12-3, and two DI water chambers 12-2, 12-4. The two chemical chambers are hydrofluoric acid chamber 12-1 and SC1 chamber 12-3. Each chamber 12 has its own pipeline 14 attached, for example, hydrofluoric acid is introduced by the pipeline 14-1 to the hydrofluoric acid chamber 12-1. Wafer 1 is clipped and put into chamber 12-1 by robot 5. This kind of chemical cleaning technique has been controlled automatically, and the operator only needs to put the wafer that has to be cleaned into the input of wet bench, then according to the process flow and cleaning recipe, robot 5 will put the wafer into one acid chamber in wet bench cleaning processor. The general cleaning processor includes the function of chemical change, temperature control, time control, robot operation, acid chamber concentration control, and warning system. Using different acid bath in wet bench cleaning processor, different cleaning recipe can be reached.

Referring to FIG. 2, a conventional spray chemical processor 20 is shown. In this processor, different chemical solutions are put into different tanks 22, and introduced to a flow controller and a mixture pipeline 21 that is required by a cleaning recipe for high pressure N₂. Then, the chemical solution through pipeline 23 to spray-post 24 sprays uniformly on the wafer 1 in chamber 25. This kind of cleaning method is that wafer 1 is mounted on the turntable 26 in chamber 25. The fresh chemical solution pressured by nitrogen sprays uniformly on the wafer 1 from spray-post 24 as cleaned and rinsed by DI water, and the rotational speed of turntable 26 will depend on the cleaning recipe to change automatically that will reach the best cleaning performance. The chemical solution will be discarded after every cleaning process, so the cleaning process has fresh chemical solution as compare to the wet bench cleaning processor which has run time of chemical change from 8 to 12 hours or batch from 20 to 30 times so that the contamination in chemical bath will increase with the cleaned wafers and metal ions as well as organic accumulated. Further, the wafer on the turntable is rinsed by DI water between different chemical solution for preventing cross contamination.

Single bath cleaning processor is also called enclosed-vessel chemical cleaning system. Referring to FIG. 3, a conventional single bath cleaning processor 30 is shown. Different chemical solution in each tank 31 via valve 32 controlled by cleaning recipe will flow through pipeline 33 into chamber 34 which is a single enclosed vessel. Moreover, a drain 35 is on the cleaning bath 34. This chemical cleaning technique is that wafer is put into the enclosed single cleaning bath 34 and then different chemical solution is introduced to bath to clean wafer by cleaning recipe. Before cleaning, wafer is put in the slot of the enclosed bath and closed, then different chemical solution is introduced sequentially to clean wafer. Similarly, wafer is rinsed by DI water between different chemical solution for preventing cross contamination.

In certain semiconductor processes, such as post HYDROFLUORIC acid etching process, wafer is easy to be adhered by particles, because the surface of wafer is hydrophobic and bare silicon is easy reacted with particles by its cleaning bond. Referring to FIG. 4, wafer 1 is put in the bath 3 to immerse in chemical solution 2. When the wafer 1 is taken out by robot, particles will attach on the surface of wafer from micropoint of view. It is difficult to treat the surface of wafer after Hydrofluoric acid etching process, and the amount of particles is generally greater. Therefore, a second cleaning process, SC1is added to remove particles out of wafer surface after Hydrofluoric acid etching process, and hence increasesd limitation.

Furthermore, the function of RCA cleaning is to remove particles, metal ions, or silicon oxide, and all these processes need chemical. However, chemical in conventional cleaning processors will cause the following defect. First, the SCI (NH₃/H₂O₂/H₂O) recipe will etch silicon oxide and tungsten silicide to cause roughness of bare silicon. Second, SC1 cleaning will cause the metal ion contamination that needs SC2 recipe to clean. Moreover, some pattern can not use chemical due to lightly etching photoresist layer.

### SUMMARY OF THE INVENTION

In accordance with the present invention, a method is provided for preventing the re-adherence of particles in wafer-cleaning process that substantially will not etch silicon oxide, tungsten silicide, and photoresist. Further, the cleaning process of this invention will not cause metal ion contamination.

It is another object of this invention that this process can apply to the spray chemical processor, scrubber, and jet system.

It is a further object of this invention that this process can prevent the re-adherence of particles without chemical.

It is still another object of this invention that this process cost less and does not need to be treated for contamination.

It is yet another object of this invention that this process can apply to the photoresist cleaning that won't make any damage to wafers.

In one embodiment, an apparatus for preventing the re-adherence of particles in wafer cleaning process is provided. The apparatus comprises a tank containing dissolved high pressure gas water, wherein the pressure of the high pressure gas water is between about 1 to 5 atmosphere pressure, a cleaning bath for cleaning wafer, and a vent on the cleaning bath. The present invention further provides a pipeline connecting the tank and the cleaning bath, such that the high pressure gas water forms a plurality of bubbles on the surface of the wafer and particles after the high pressure gas water in the tank introduction into the cleaning bath, in which the particles near the wafer is push away from the wafer by the bubbles and the particles away from the wafer will not re-adhere to the surface of wafer for the repulsion of the bubbles, and a valve on the pipeline for controlling its turn-on or turn-off.

The present invention simultaneously provides a method for preventing particle re-adhering in wafer cleaning process. The method comprises first providing a tank, a cleaning bath, and a pipeline connecting the tank and the cleaning bath. Then, a dissolved high pressure gas water is provided in the tank. Next, the dissolved high pressure gas water is introduced into the cleaning bath, such that the high pressure gas water forms a plurality of bubbles on the surface of the wafer and particles, in which the particles near the wafer is push away from the wafer by the bubbles and the particles away from the wafer will not re-adhere to the surface of wafer for the repulsion of the bubbles.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic representation of prior wet bench cleaning processor in clean station;

FIG. 2 is a schematic representation of prior spray chemical cleaning processor in clean station;

FIG. 3 is a schematic representation of prior single bath cleaning processor in clean station;

FIG. 4 is a schematic representation showing particles attaching the surface of wafer in wet bench cleaning processor using conventional, prior art techniques;

FIG. 5 is a schematic representation showing bubbles taking particles away from the surface of a wafer in accordance with the present invention disclosed;

FIG. 6 is a schematic representation showing the cleaning apparatus in accordance with the present invention disclosed;

FIG. 7 is a schematic representation showing the application on the single bath cleaning processor in accordance with the present invention disclosed; and

FIG. 8 is a schematic representation showing the application on the wet bench cleaning processor in accordance with the present invention disclosed.

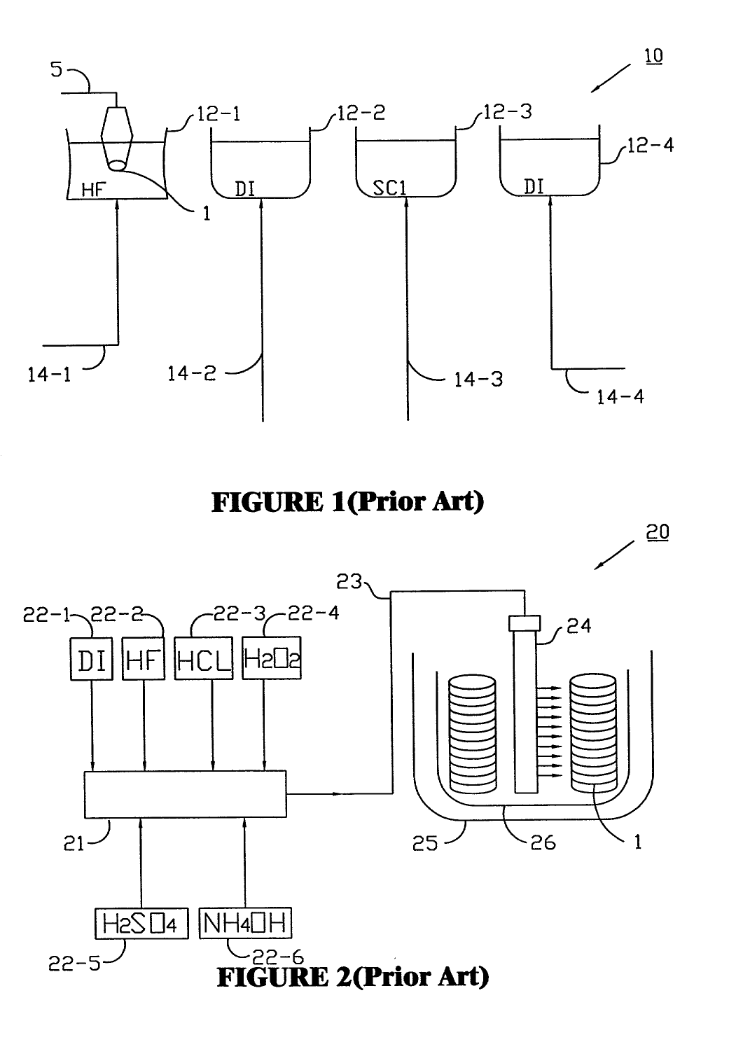

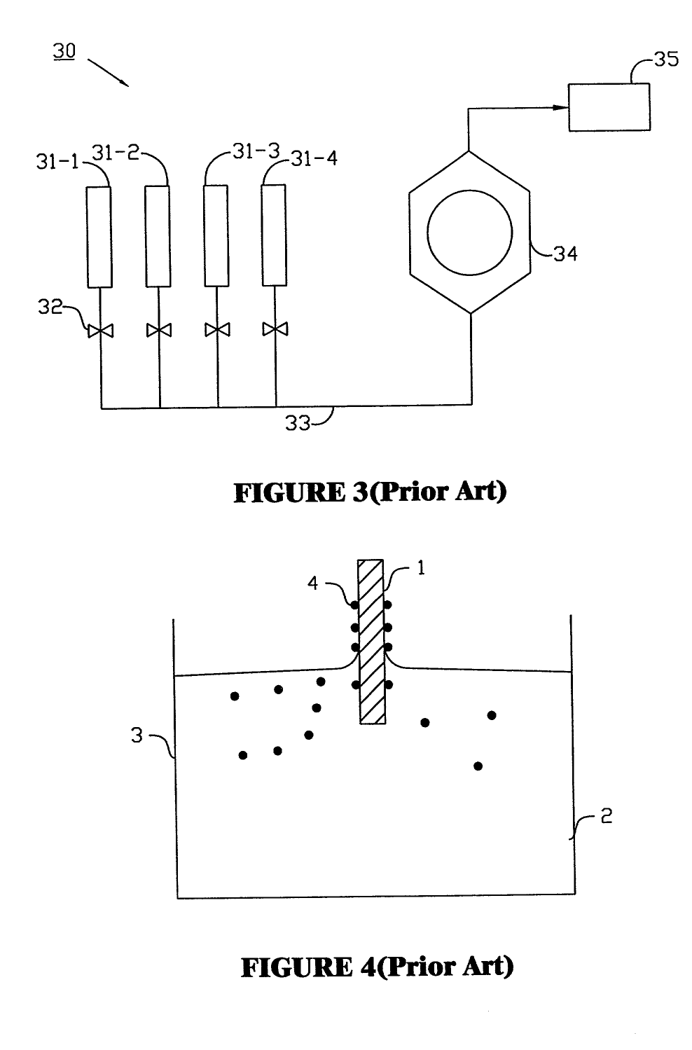

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

The present invention utilizes high pressure water to remove particles. When high pressure water reaches the low pressure cleaning bath, the pressure will be released. For example, when we open a soda water, bubbles comprising CO₂ will fizz up. Therefore, the gas dissolved in water will be released to form bubble layers in cleaning bath. There are two functions in this place. First, bubbles will grow up and repulse particles, and with the megasonic bubbles are ductility and massage particles out of wafer. Further, there are repulsive forces between bubble layers to make particles not to re-adhere wafer.

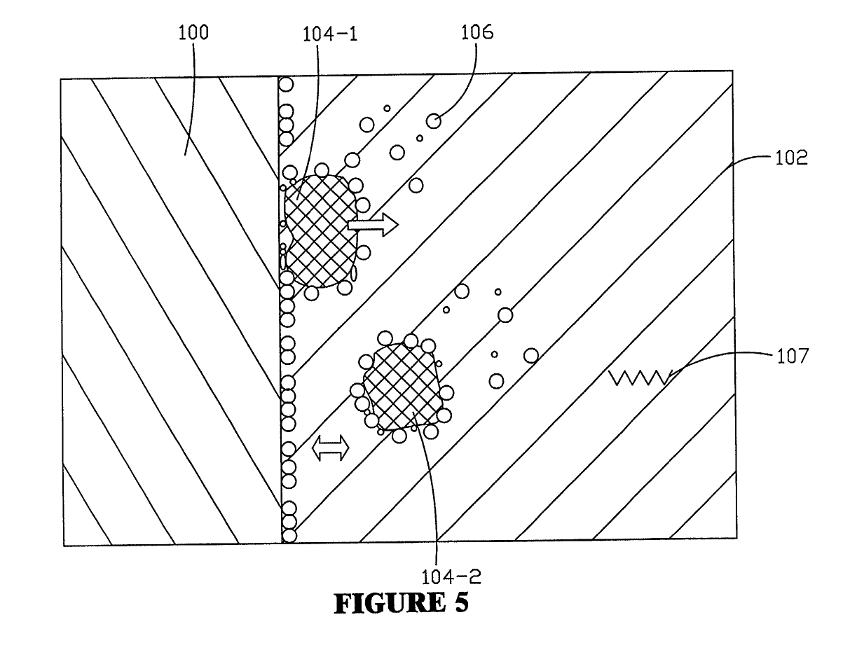

FIG. 5 shows bubbles, which may be O₂, CO₂, or N₂, taking particles away from the surface of a wafer in accordance with the present invention is disclosed. The applied gas depends on the requirement of process, easily reactive with wafer, or dissolvable in water. In general, air, O₂, CO₂, and N₂, posses the above requirement, but other gases, such as inert gas, also satisfy the above requirement. The high pressure gas in water will not generate bubble in any place, but will generate at the place between water and other interface. For example, bubbles are released and formed only on the inner side of a glass in pure water. In FIG. 5, wafer 100 is put in high pressure water 102, and bubbles 106 are formed on the surface of wafer 100 and particles 104. Particle 104-1 attached on the wafer 100 will be repulsed way from wafer 100 by bubbles 106, and particle 104-2 away from wafer 100 will not re-adhere to the surface of wafer 100 due to the repulsive forces between bubbles. Certainly, a certain amount of heat is provided for easily generating bubbles. In the present invention, bubbles are formed on the surfaces of wafer and particles and not formed in water. Further, with the aid of megasonic 107 particle 104 will leave wafer 100 easily, because water molecule is vibrated by megasonic to push bubbles and particles away from wafer.

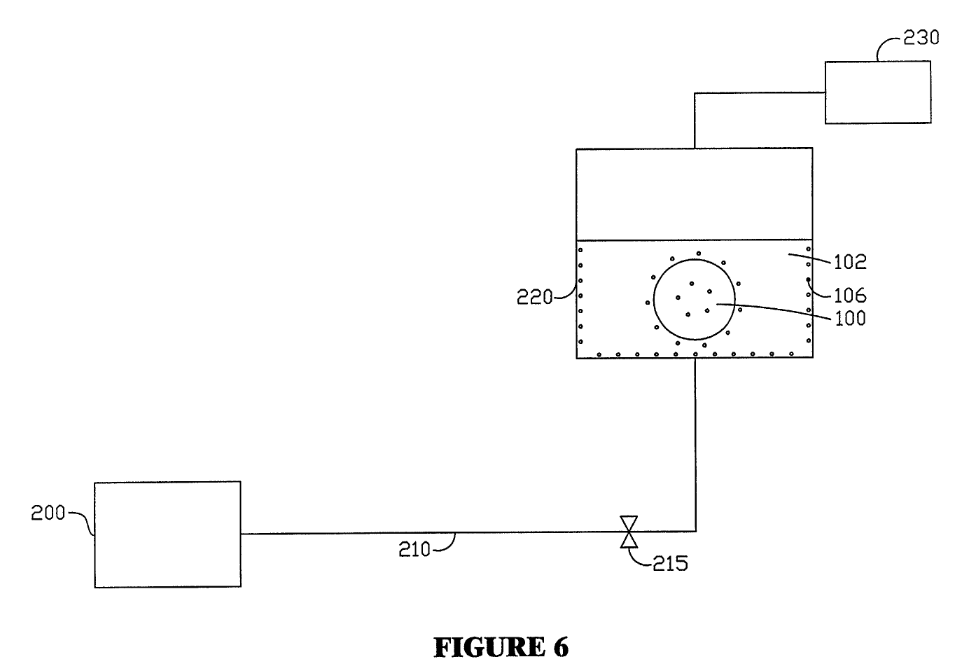

The following will set forth the apparatus according to the present invention. Referring to FIG. 6, a tank 200 contains high pressure water between 1 atm to 5 atm, and a pipeline 210 connects tank 200 to a cleaning bath 220. There is a valve 215 on the pipeline 210 to control whether high pressure water in tank 200 flows to bath 220. In the cleaning bath 220, a wafer 100 is immersed in the high pressure water 102, then bubbles 106 are formed on the inner side of cleaning bath 220 and surface of wafer 100 from high pressure water 102. There is a drain 230 on the bath 220 to vent gas in cleaning bath 220 to keep constant pressure.

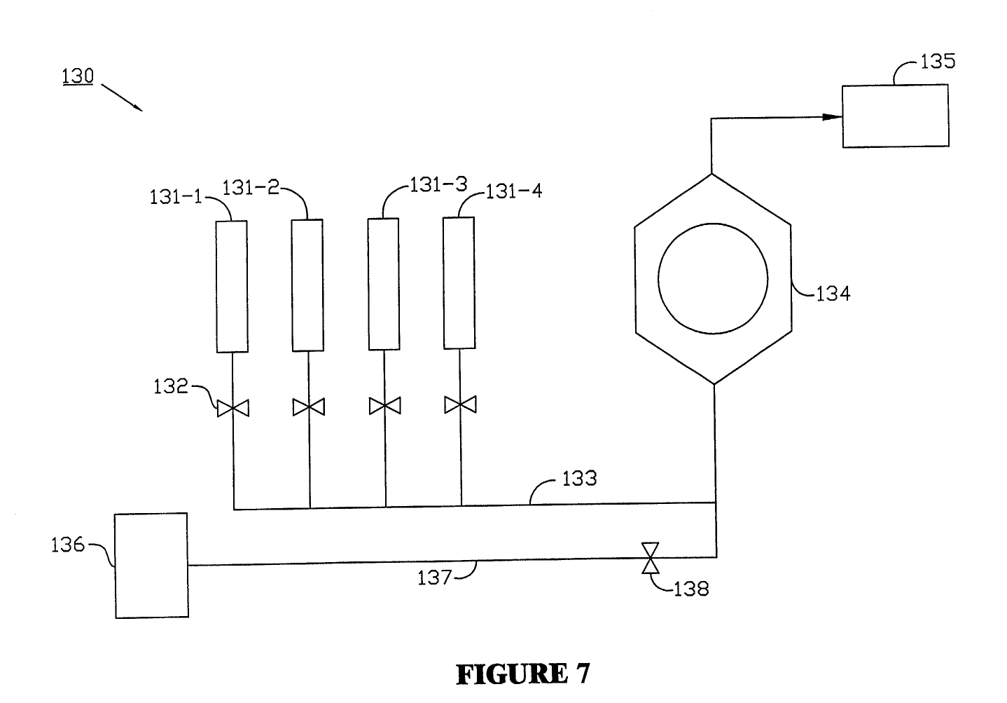

It is easy that the present invention can apply to every kinds of cleaning processor, such as single bath cleaning processor. Referring to FIG. 7, a single bath cleaning processor in accordance with present invention is shown, in which different chemical solution stored in themselves tanks 131 via valve 132 controlled by cleaning recipe flow through pipeline 133 into cleaning bath 134 which is an enclosed single vessel. Further, a drain 135 is on the cleaning processor 34. The differences to the prior art are to increase another pipeline 137 to connect a cleaning bath 134 and tank 136 within high pressure water and a valve 138 on the pipeline 137. After chemical solution flows through pipeline 130 into cleaning bath 134 and cleans wafer, the high pressure water in tank 136 will flow into cleaning bath 134 to rinse wafer, and then let other chemical solution flow into bath 134.

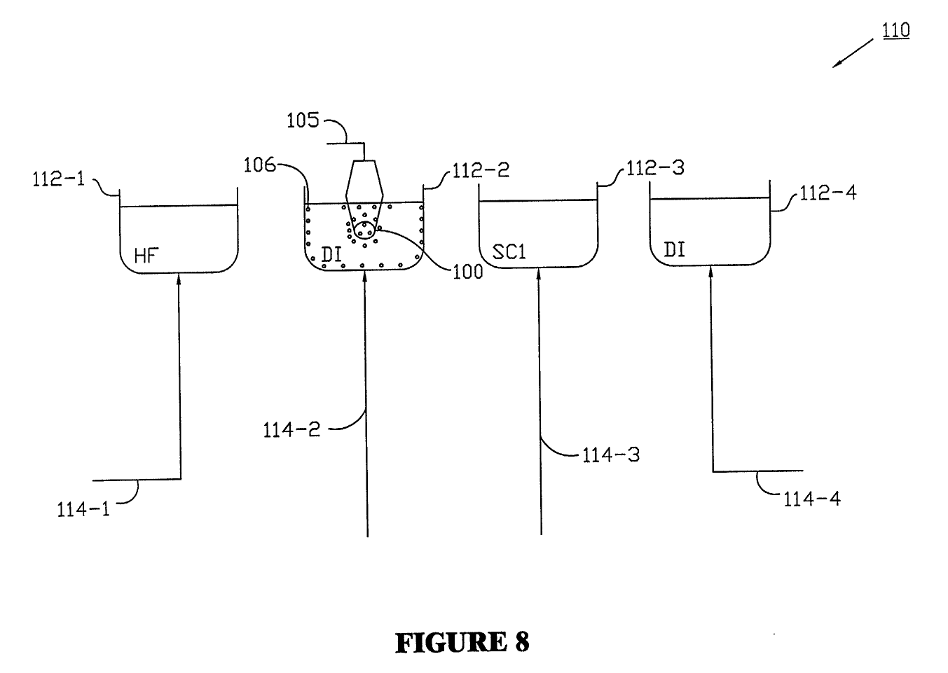

Referring to FIG. 8, a wet bench cleaning processor in accordance with present invention is shown, which has two chemical chambers 112-1, 112-3, and two DI water chambers 112-2, 112-4. The two chemical chambers are hydrofluoric acid chamber 112-1 and SC1 chamber 112-3. Each chamber 112 has its own pipeline 114 to attached, for example, hydrofluoric acid is introduced by the pipeline 114-1 to the hydrofluoric acid chamber 112-1. Wafer 100 is clipped to put into chamber 112-2 to rinse by robot. In this embodiment, only high pressure water needs to be introduced into chambers 112-2, 112-4 to rinse wafer so better performance and less particle re-adherence can be reached.

The present invention except applying single bath cleaning processor and wet bench cleaning processor, further applying any other wet cleaning processors, such as spray chemical cleaning processor, scrubber, and jet system. Because all wet cleaning processors need DI water to rinse wafer, better performance can be reached in accordance with the present invention when replacing the conventional DI water rinse.

Moreover, the present invention applies to post Hydrofluoric acid etching process appropriately, due to particles created from the etched silicon oxide after Hydrofluoric acid etching will re-adhere to bare silicon. After Hydrofluoric acid etching process, the surface of bare silicon is protected by bubble layer, and particles are taken away by bubbles and overflow so that particles can not re-adhere to wafer. Hence, no SC1 cleaning process is performed after Hydrofluoric acid etching process. That means the present invention is a better cleaning process after Hydrofluoric acid etching process.

Further, in pre-gate oxide cleaning process, the requirement of cleanliness and surfacing is severe, so any native oxide, particle, and metal ions can not exist on the surface of wafer. The present invention applies to pre-gate oxide cleaning process will not generate any roughness on the wafer surface due to water will not etch silicon oxide, tungsten silicide and no particle generated. Besides, there is no metal ion generated to cause contamination for no H₂O₂, and hence no sewage work is need for treating chemical.

Furthermore, the present invention can apply to cleaning photoresist pattern because the only cleaning solution is water, and hence no photoresist is removed.

To sum up, the present invention provides a method for preventing the re-adherence of particles in wafer-cleaning process that substantially will not etch silicon oxide, tungsten silicide, and photoresist. Further, the cleaning process of this invention will not cause metal ion contamination. Moreover, this invention can apply to the spray chemical processor, scrubber, and jet system. Besides, this invention can prevent the re-adherence of particles without chemical. Furthermore, this invention cost less and does not need to be treated for contamination. In addition, this invention can apply to the photoresist cleaning since it won't cause any damage to wafers.

Although specific embodiments have been illustrated and described, it will be obvious to those skilled in the art that various modifications may be made without departing from what is intended to be limited solely by the appended claims.

What is claimed is:

1. An apparatus for preventing the re-adherence of particles in wafer cleaning process, said apparatus comprising:
a tank containing dissolved high pressure gas water;
a cleaning bath for cleaning wafer; and
a pipeline connecting said tank and said cleaning bath, such that the high pressure gas water forms a plurality of bubbles on the surface of the wafer and particles after the high pressure gas water in said tank introduction into said cleaning bath, in which the particles near the wafer is pushed away from the wafer by the bubbles and the particles away from the wafer will not re-adhere to the surface of the wafer for the repulsion of the bubbles.

2. The apparatus according to claim 1, wherein the pressure of the high pressure gas water is between about 1 to 5 atmosphere pressure.

3. The apparatus according to claim 1, wherein said dissolved gas is selected from the group consisting of air, O₂, CO₂, and N₂.

4. The apparatus according to claim 1, further comprising a valve on said pipeline for controlling its turn-on or turn-off.

5. The apparatus according to claim 1, further comprising a vent.

6. The apparatus according claim 1, further comprising performing megasonic on the high pressure water in said cleaning bath.

7. The apparatus according to claim 1, further comprising a plurality of containers for different chemical solution when applying to the single bath cleaning processor.

8. The apparatus according to claim 7, further comprising a plurality of pipelines for connecting said containers and said cleaning bath to introduce the chemical solution into said cleaning bath.

9. The apparatus according to claim 1, further comprising a plurality of containers for different chemical solution when applying to the spray chemical cleaning processor.

10. The apparatus according to claim 9, further comprising a plurality of pipelines for connecting said containers and said cleaning bath to introduce the chemical solution into said cleaning bath.

11. The apparatus according to claim 1, further comprising a plurality of containers for different chemical solution when applying to the wet bench cleaning processor.

12. The apparatus according to claim 1, wherein said wafer cleaning process applies in scrubber or spray system.

13. An apparatus for preventing the re-adherence of particles in wafer cleaning process, said apparatus comprising:
a tank containing dissolved high pressure gas water, wherein the pressure of the high pressure gas water is between about 1 to 5 atmosphere pressure;
a cleaning bath for cleaning wafer;
a vent on said cleaning bath;
a pipeline connecting said tank and said cleaning bath, such that the high pressure gas water forms a plurality of bubbles on the surface of the wafer and particles after the high pressure gas water in said tank introduction into said cleaning bath, in which the particles near the wafer is push away from the wafer by the bubbles and the particles away from the wafer will not re-adhere to the surface of the wafer for the repulsion of the bubbles; and
a valve on said pipeline for controlling its turn-on or turn-off.

14. The apparatus according to claim 13, wherein said dissolved gas is selected from the group consisting of air, O₂, CO₂, and N₂.

15. The apparatus according to claim 13, further comprising performing megasonic on the high pressure water in said cleaning bath.

16. The apparatus according to claim 13, further comprising a plurality of containers for different chemical solution when applying to the single bath cleaning processor.

17. The apparatus according to claim 16, further comprising a plurality of pipelines for connecting said containers and said cleaning bath to introduce the chemical solution into said cleaning bath.

18. The apparatus according to claim 13, further comprising a plurality of containers for different chemical solution when applying to the spray chemical cleaning processor.

19. The apparatus according to claim 18, further comprising a plurality of pipelines for connecting said containers and said cleaning bath to introduce the chemical solution into said cleaning bath.

20. The apparatus according to claim 13, further comprising a plurality of containers for different chemical solution when applying to the wet bench cleaning processor.

21. The apparatus according to claim 13, wherein said wafer cleaning process applies in scrubber or spray system.

22. A method for preventing particle re-adhering in wafer cleaning process, said method comprising:
providing a tank, a cleaning bath, and a pipeline connecting said tank and said cleaning bath;
providing a dissolved high pressure gas water in said tank; and
introducing said dissolved high pressure gas water into said cleaning bath, such that said high pressure gas water forms a plurality of bubbles on the surface of the wafer and particles, in which the particles near the wafer is push away from the wafer by the bubbles and the particles away from the wafer will not re-adhere to the surface of the wafer for the repulsion of the bubbles.

23. The method according to claim 22, wherein the pressure of the high pressure gas water is between about 1 to 5 atmosphere pressure.

24. The method according to claim 22, wherein said dissolved gas is selected from the group consisting of air, O₂, CO₂, and N₂.

25. The method according to claim 22, further comprising a valve on said pipeline for controlling its turn-on or turn-off.

26. The method according to claim 22, further comprising a vent.

27. The method according to claim 22, further comprising performing megasonic on the high pressure water in said cleaning bath.

28. The method according to claim 22, further comprising a plurality of containers for different chemical solution when applying to the single bath cleaning processor.

29. The method according to claim 28, further comprising a plurality of pipelines for connecting said containers and said cleaning bath to introduce the chemical solution into said cleaning bath.

30. The method according to claim 22, further comprising a plurality of containers for different chemical solution when applying to the spray chemical cleaning processor.

31. The method according to claim 30, further comprising a plurality of pipelines for connecting said containers and said cleaning bath to introduce the chemical solution into said cleaning bath.

32. The method according to claim 22, further comprising a plurality of containers for different chemical solution when applying to the wet bench cleaning processor.

33. The method according to claim 22, wherein said wafer cleaning process applies in scrubber or spray system.

34. A method for cleaning wafer after hydrofluoric acid etching process, said method applying to single bath cleaning processor, said method comprising:
providing a tank, a cleaning bath, and a pipeline connecting said tank and said cleaning bath;
providing a dissolved high pressure gas water in said tank, wherein the pressure of the high pressure gas water is between about 1 to 5 atmosphere pressure;
introducing said dissolved high pressure gas water into said cleaning bath, such that said high pressure gas water forms a plurality of bubbles on the surface of the wafer and particles, in which the particles near the wafer is push away from the wafer by the bubbles and the particles away from the wafer will not re-adhere to the surface of the wafer for the repulsion of the bubbles; and
performing megasonic on said high pressure water in said cleaning bath.

35. The method according to claim 34, wherein said dissolved gas is selected from the group consisting of air, O₂, CO₂, and N₂.

36. The method according to claim 34, further comprising a valve on said pipeline for controlling its turn-on or turn-off.

37. The method according to claim 34, further comprising a vent.
